(19) United States
(12) Patent Application Publication
(10) Pub. No.: US 2026/0049483 A1
(43) Pub. Date: Feb. 19, 2026

(54) Multilayer Flooring Including Locking System for Joining Floorboards Together

(71) Applicant: Donald R. FINKELL, JR., Rocky Face, GA (US)

(72) Inventor: Donald R. FINKELL, JR., Rocky Face, GA (US)

(21) Appl. No.: 19/299,161

(22) Filed: Aug. 13, 2025

Related U.S. Application Data
(60) Provisional application No. 63/683,094, filed on Aug. 14, 2024.

(51) Int. Cl. E04F 15/10; B32B 3/06; B32B 7/03; B32B 21/02; E04F 15/02

(52) U.S. Cl. CPC E04F 15/107; B32B 3/06; B32B 7/03; B32B 21/02; E04F 15/02038; B32B 2250/04; B32B 2471/00; E04F 2201/0115; E04F 2201/0146; E04F 2201/0161; E04F 2201/043; E04F 2290/041

(57) ABSTRACT

A multilayer flooring includes floorboards that each have a male edge and a female edge, the male edge including a tongue, the female edge defining a groove. The tongue of one of the floorboards is insertable into the groove of another one of the floorboards to lock the floorboards together. Each of the floorboards includes a decorative layer configured to provide a desired appearance of the multilayer flooring. The decorative layer is made of a first material, and a core layer disposed below the decorative layer and configured to provide at least one of stability, sound deadening, cushioning, and durability. The core layer is made of a second material that is less rigid than the first material, and the core layer makes up at least a portion of at least one of the tongue and the groove.

### CROSS-REFERENCE TO RELATED APPLICATIONS

This application claims the benefit of U.S. Provisional Application No. 63/683,094, filed on Aug. 14, 2024. The entire disclosure of the application referenced above is incorporated herein by reference.

### FIELD

The present disclosure relates to multilayer flooring including a locking system for joining floorboards together.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Multilayer flooring has become a viable alternative to hardwood flooring, or solid wood flooring, due to reduced cost, water resistance, and less maintenance. Three types of multilayer flooring are laminate flooring, vinyl flooring, and engineered wood flooring. Vinyl flooring includes luxury vinyl plank (LVP) and luxury vinyl tile (LVT).

Multilayer flooring typically includes a decorative layer and a core layer. The decorative layer provides the desired appearance of a floor such as that of hardwood flooring. The core layer is disposed below the decorative layer and provides stability, durability and, in some cases, water resistance. Some types of multilayer flooring also include a wear layer disposed above the decorative layer and/or a backing layer disposed below the core layer. The wear layer is typically transparent, protects the floor against scratches and stains, and, in some cases, minimizes damage from exposure to ultraviolet rays. The backing layer provides additional stability and/or water resistance.

In laminate flooring, the core layer is typically made of melamine resin and fiberboard. In vinyl flooring, the core layer is typically made of wood plastic composite (WPC), stone plastic composite (SPC), magnesium oxide (MGO), or polyvinyl chloride (PVC). In engineered wood flooring, the core layer is typically made of plywood, medium-density fiberboard (MDF), or high-density fiberboard (HDF).

### SUMMARY

An example of multilayer flooring according to the present disclosure includes floorboards that each have a male edge and a female edge, the male edge including a tongue, the female edge defining a groove. The tongue of one of the floorboards is insertable into the groove of another one of the floorboards to lock the floorboards together. Each of the floorboards includes a decorative layer configured to provide a desired appearance of the multilayer flooring. The decorative layer is made of a first material, and a core layer disposed below the decorative layer and configured to provide at least one of stability, sound deadening, cushioning, and durability. The core layer is made of a second material that is less rigid than the first material, and the core layer makes up at least a portion of at least one of the tongue and the groove.

In one aspect, a ratio of a thickness of the core layer to at least one of a maximum thickness of the tongue and a maximum height of the groove is within a range from 0.5 to 0.9.

In one aspect, the first material is selected from a group consisting of wood, wood plastic composite (WPC), stone plastic composite (SPC), magnesium oxide (MGO), medium-density fiberboard (MDF), and high-density fiberboard (HDF), and the second material is selected from a group consisting of cork and a nonwoven material.

In one aspect, the decorative layer makes up a top portion of at least one of the tongue and the groove.

In one aspect, the multilayer flooring further includes a backing layer disposed below the core layer. The decorative and backing layers make up the top and bottom portions, respectively, of at least one of the tongue and the groove.

In one aspect, the backing layer is also made of the first material.

Another example of multilayer flooring according to the present disclosure includes a first floorboard having a first edge defining a first tongue and a first groove, and a second floorboard having a second edge defining a second tongue and a second groove. The first tongue of the first floorboard is insertable into the second groove of the second floorboard, and the second tongue of the second floorboard is insertable into the first groove in the first floorboard, to lock the first and second floorboards together. Each of the first and second floorboards includes a first layer, a second layer, and a core layer disposed between the first and second layers. At least one of the first and second layers is made of a first material and the core layer is made of a second material that is less rigid than the first material. The core layer makes up at least a portion of the first and second tongues.

In one aspect, both the first and second layers are made of the first material.

In one aspect, the first material is selected from a group consisting of wood, wood plastic composite (WPC), stone plastic composite (SPC), magnesium oxide (MGO), medium-density fiberboard (MDF), and high-density fiberboard (HDF), and the second material is selected from a group consisting of cork and a nonwoven material.

In one aspect, the core layer makes up at least a portion of the first and second grooves.

In one aspect, the multilayer flooring further includes a third layer disposed above the first layer and a fourth layer disposed below the second layer. The first, second, third, and fourth layers are made of the first material.

In one aspect, the first material is wood, the first and second layers have a grain direction that extends along one of a floorboard length and a floorboard width, and the third and fourth layers have a grain direction that extends along the other one of the floorboard length and the floorboard width.

In one aspect, the geometry of the first edge of the first floorboard is different than the geometry of the second edge of the second floorboard.

In one aspect, the geometry of the first edge of the first floorboard is identical to the geometry of the second edge of the second floorboard.

Another example of a multilayer flooring according to the present disclosure includes a first floorboard having an edge defining a tongue, and a second floorboard having an edge defining a groove. The tongue of the first floorboard is insertable into the groove of the second floorboard to lock the first and second floorboards together. Each of the first and second floorboards includes a first layer, a second layer, and a core layer disposed between the first and second layers. At least one of the first and second layers is made of a first material and the core layer is made of a second material that is less rigid than the first material. The core layer makes up at least a portion of the tongue. The first and second floorboards can be disassembled from one another without breaking the tongue.

In one aspect, the first and second floorboards are assembled to one another by moving one of the first and second floorboards in a primarily horizontal direction toward the other one of the first and second floorboards.

In one aspect, the first and second floorboards are assembled to one another by moving one of the first and second floorboards in a primarily vertical direction toward the other one of the first and second floorboards.

In one aspect, the core layer makes up a majority of the tongue.

In one aspect, the edge of the first floorboard also defines a groove and the edge of the second floorboard also defines a tongue, and the tongues of the first and second floorboard are insertable into the grooves of the first and second floorboards to lock the first and second floorboards together.

In one aspect, one edge of the first floorboard defines the tongue and the opposite edge of the first floorboard defines a groove, one edge of the second floorboard defines the groove in the second floorboard and the opposite edge defines a tongue, the tongues of the first and second floorboard are insertable into the grooves of the first and second floorboards to lock the first and second floorboards together, the multilayer flooring includes a plurality of the first floorboard and a plurality of the second floorboard, and when the first and second floorboards are assembled together with the first floorboards disposed between adjacent ones of the second floorboards, one of the first or second floorboards disposed between adjacent ones of the other one of the first or second floorboards can be disassembled from the multilayer flooring without disassembling other ones of the first and second floorboards or breaking the tongues.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a sectioned perspective view of an example of a floor structure according to the principles of the present disclosure adjoining a wall structure;

FIG. 2 is a section view of two boards of the floor structure of FIG. 1 disassembled from one another;

FIG. 3 is a section view of the two boards of the floor structure of FIG. 1 being assembled to one another with dashed lines showing an exaggeration of a male edge of one board being compressed and a female edge of the other board being spread apart;

FIG. 4 is a section view of the two boards of the floor structure of FIG. 1 assembled to one another;

FIGS. 5 through 7 are section views of a tool making various cuts to create the male edge of the one board of the floor structure of FIG. 1;

FIGS. 8 through 10 are section views of a tool making various cuts to create the female edge of the other board of the floor structure of FIG. 1;

FIG. 11 is a section view of another example of two boards according to the principles of the present disclosure disassembled from one another;

FIG. 12 is a section view of the two boards of FIG. 11 being assembled to one another with dashed lines showing edges of the boards prior to deformation of the edges as a result of the assembly;

FIG. 13 is a section view of the two boards of FIG. 11 assembled to one another;

FIGS. 14 through 16 are section views of a tool making various cuts to create the edge of a top board of the two boards of FIG. 11;

FIGS. 17 through 19 are section views of a tool making various cuts to create the edge of a bottom board of the two boards of FIG. 11;

FIG. 20 is a section view of another example of two boards according to the principles of the present disclosure assembled to one another;

FIG. 21 is a section view of another example of two boards according to the principles of the present disclosure assembled to one another;

FIG. 22 is a section view of another example of two boards according to the principles of the present disclosure assembled to one another;

FIG. 23 is a section view of another example of two boards according to the principles of the present disclosure assembled to one another; and

FIG. 24 is a section view of another example of two boards according to the principles of the present disclosure assembled to one another.

In the drawings, reference numbers may be reused to identify similar and/or identical elements.

### DETAILED DESCRIPTION

Multilayer flooring may be joined together using tongue and groove joints, in which case each of the floorboards that makeup the multilayer flooring has a male edge and a female edge. The male edge includes a tongue, and the female edge defines a groove. The tongue of one floorboard is inserted into the groove of an adjacent floorboard to lock the floorboards to one another.

When tongue and groove joints are used with multilayer flooring, the core layer makes up at least a portion of the male and female edges of the floorboards. Thus, when the multilayer flooring includes a core layer made of the materials listed above, the tongue and the groove are relatively rigid. Therefore, the female edge typically does not entirely surround the groove therein to provide clearance for inserting the tongue into the groove. Additionally, locking the floorboards together may require rotating the floorboards about their male and female edges to rotate the tongue into the groove, which may be cumbersome, especially for floorboards having large widths and lengths as is increasingly more common. Furthermore, the floorboards typically cannot be disassembled and reassembled without breaking the tongue due to the stiffness thereof.

An example of a multilayer flooring according to the principles of the present disclosure includes floorboards with tongue and groove joints, and each floorboard includes a decorative layer, a core layer, and a backing layer. The core layer is made of a material that is less rigid than the material from which the decorative and backing layers are made. In one example, the decorative and backing layers are made of wood, WPC, SPC, MGO, MDF, and/or HDF, and the core layer is made of cork or a nonwoven material such as a sound deadening pad. The core layer makes up at least a portion of the tongue and the groove.

Since the core layer is flexible or pliable relative to the decorative and backing layers, when the tongue of one floorboard is inserted into the groove of another floorboard, the tongue compresses and the groove expands. Thus, the female edge may be designed to entirely surround the groove and closely match the size and shape thereof, which yields a tighter lock between the tongue and the groove. In addition, the floorboards may be locked together by simply moving the male and female edges of the floorboards toward one another in a single direction parallel to the widths thereof without rotating the floorboards. Alternatively, the floorboards may be locked together by moving the male edge toward the female edge or vice versa in a vertical direction perpendicular to the widths of the floorboards, possibly by stepping on the floorboards to engage the male and female edges. Furthermore, the floorboards can be disassembled and reassembled without breaking the tongue.

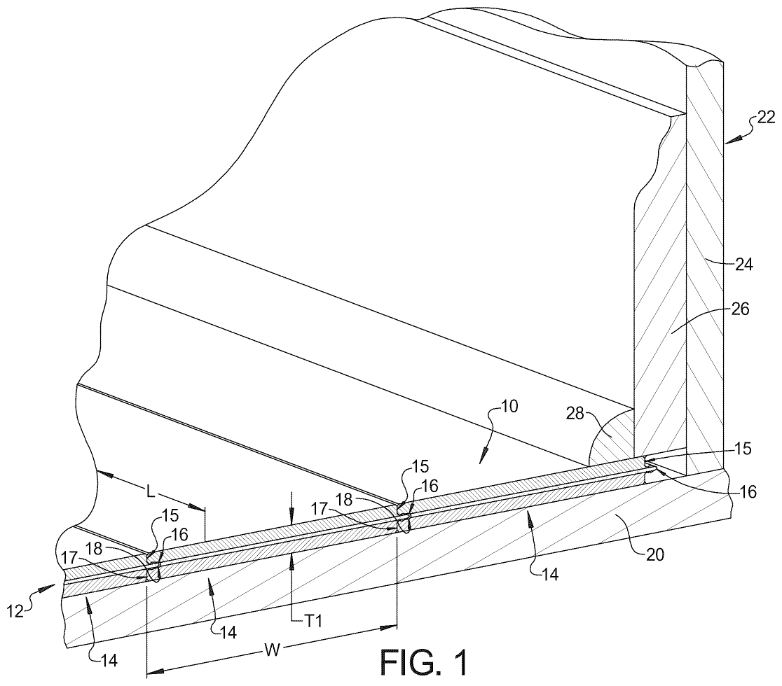

Referring now to FIG. 1, a floor structure 10 includes multilayer flooring 12 made up of floorboards 14. Each floorboard 14 has a male edge 15 including a tongue 16 and a female edge 17 defining a groove 18. The tongue 16 of one floorboard 14 is inserted into the groove 18 of an adjacent floorboard 14 to lock the floorboards 14 together. The floorboards 14 may be referred to as tongue-and-groove floorboards.

In the example shown, the floor structure 10 further includes a subfloor 20 that supports the multilayer flooring 12, and the floor structure 10 adjoins a wall structure 22. The subfloor 20 may be made of plywood, particle board, concrete slab, or existing hard surface flooring such as ceramic tile. The wall structure 22 includes an interior finish wall (e.g., drywall) 24, a baseboard 26, and a quarter round molding 28. In various implementations, the floor structure 10 also includes a flooring underlayment (not shown) disposed between the flooring 12 and the subfloor. The flooring underlayment compensates for imperfections in the subfloor 20 to provide a smooth and/or level surface, provide noise reduction, mitigate moisture damage to the multilayer flooring 12, and/or provides cushioning.

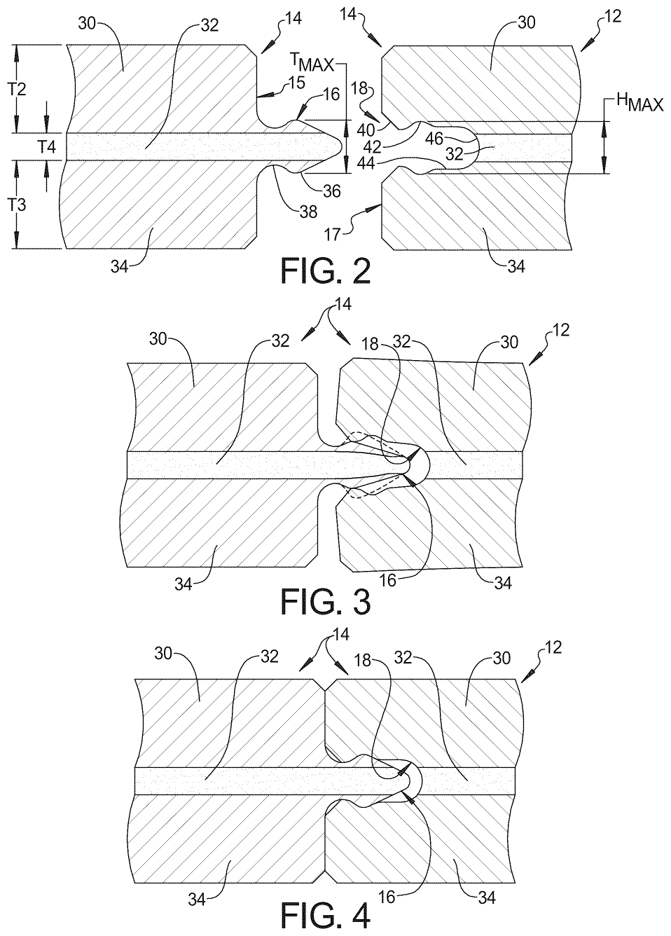

Referring now to FIGS. 2 through 4, assembly of two of the floorboards 14 to one another is illustrated. FIG. 2 shows two of the floorboards 14 disassembled from one another with the tongue 16 of one floorboard 14 spaced apart from the groove 18 of another floorboard 14. FIG. 3 shows the tongue 16 of the one floorboard 14 being inserted into the groove 18 of the other floorboard 14. FIG. 4 shows the floorboards 14 joined together with the tongue 16 of the one floorboard fully inserted into the groove 18 of the other floorboard 14.

Each floorboard 14 includes a decorative layer 30, a substrate or core layer 32, and a backing layer 34. The multilayer flooring 12 has a structure similar or identical to laminate flooring, vinyl flooring (e.g., LVP or LVT), or engineered wood flooring except for the core layer 32. Instead of being made from a material such as WPC, SPC, MGO, PVC, plywood, MDF, or HDF, the core layer 32 is made of a less rigid material. The dimensions (e.g., thickness) and geometry (e.g., cross-sectional shape) of the core layer 32 may also be adjusted to account for differences in its material properties relative to conventional core layers. The decorative layer 30, the core layer 32, and the backing layer 34 may be joined to one another using adhesive.

Each floorboard 14 has a width W, a length L, and a thickness T1. If the multilayer flooring 12 has a structure similar to laminate flooring, the thickness T1 of each floorboard 14 may be within a range from 6 mm to 12 mm. If the multilayer flooring 12 has a structure similar to laminate plank flooring, the width W of each floorboard 14 may be within a range from 12 centimeters (cm) to 30 cm and the length L of each floorboard 14 may be within a range from 115 cm to 244 cm (8 feet).

If the multilayer flooring 12 has a structure similar to vinyl flooring, the thickness T1 of each floorboard 14 may be within a range from 2 mm to 8 mm. If the multilayer flooring 12 has a structure similar to vinyl plank flooring, the width W of each floorboard 14 may be within a range from 10 cm to 30 cm and its length L may be within a range from 90 cm to 240 cm. If the multilayer flooring 12 has a structure similar to tile flooring, the width and length of each tile may be 12 inches by 24 inches, 36 inches by 36 inches, or 48 inches by 48 inches. If the multilayer flooring 12 has a structure similar to engineered wood flooring, the width W of each floorboard 14 may be within a range from 8 cm to 30 cm, the length L of each floorboard 14 may be within a range from 90 cm to 240 cm, and the thickness T1 of each floorboard 14 may be within a range from 8 mm to 22 mm.

The decorative layer 30 provides the desired appearance of a floor such as the appearance of hardwood flooring, tile, or stone. The decorative layer 30 has a thickness T2. If the multilayer flooring 12 has a structure similar to laminate or vinyl flooring, the decorative layer 30 may be made of paper, and the desired appearance of the multilayer flooring 12 may be printed on the paper. If the multilayer flooring 12 has a structure similar to engineered wood flooring, the decorative layer 30 may be made of wood (e.g., in layers of veneer) or sawn lamellas, may be referred to as a veneer layer, and its thickness T2 may be within a range from 0.4 mm to 4 mm. In one example, the thickness T2 of the decorative layer 30 is within a range from 3 mm to 4 mm or 4.5 mm.

In various implementations, each floorboard 14 also includes a wear layer (not shown) disposed above the decorative layer 30 and joined thereto using, for example, adhesive. The wear layer is transparent, protects a floor against scratches and stains, and may minimize damage to the floor from exposure to ultraviolet (UV) rays. In various implementations, each floorboard 14 may include a UV layer that is separate from and disposed above the wear layer and is also transparent. The UV protection may be an ingredient of a chemical finish, which is applied then cured. In these implementations, the UV layer minimizes damage to the floor from exposure to UV rays, and the wear layer protects the floor against scratches and stains.

If the multilayer flooring 12 has a structure similar to laminate flooring, the wear layer may be made with aluminum oxide added to the wear layer. If the multilayer flooring 12 has a structure similar to vinyl flooring, the wear layer may be made of urethane (e.g., a urethane-based coating). If the multilayer flooring 12 has a structure similar to laminate or vinyl flooring, the thickness of the wear layer 12 may be within a range from 4 mils to 40 mils. If the multilayer flooring 12 has a structure similar to engineered wood flooring, the wear layer may be omitted and the decorative layer 30 may be referred to as a wear layer. Typically, the wood surface is coated with a protective finish. In the example shown, the wear layer is omitted, and the decorative layer 30 forms the top or exposed layer of each floorboard 14.

The backing layer 34 is disposed below the core layer 32 and provides additional stability and/or water resistance. The backing layer 34 has a thickness T3. If the multilayer flooring 12 has a structure similar to laminate flooring, the backing layer 34 may be made of wood particles and resin with melamine additive. If the multilayer flooring 12 has a structure similar to vinyl flooring, the backing layer 34 may be made of wood particles and PVC with fiberglass layers as in LVT. If the multilayer flooring 12 has a structure similar to laminate or vinyl flooring, the thickness T3 of the backing layer 34 may be within a range from 3 mm to 5 mm. If the multilayer flooring 12 has a structure similar to engineered wood flooring, the backing layer 34 may be made of wood (e.g., the same material as the decorative layer 30) and its thickness T3 may be within a range from 0.4 mm to 6 mm (e.g., the same thickness as the decorative layer 30). In one example, the thickness T3 of the backing layer 34 is within a range from 2 mm to 2.5 mm or 3 mm. Alternatively, if the multilayer flooring 12 has a structure similar to laminate flooring, vinyl flooring, or engineered wood flooring, the backing layer 34 may be omitted.

The core layer 32 is disposed below the decorative layer 30 and provides stability (e.g., firmness), sound deadening, cushioning, and durability. The core layer 32 has a thickness T4. If the multilayer flooring 12 has a structure similar to laminate or vinyl flooring, the thickness T4 of the core layer 32 may be within a range from 2 mm to 8 mm. In one example, the thickness T4 of the core layer 32 is within a range from 2 mm to 4 mm. If the multilayer flooring 12 has a structure similar to engineered wood flooring, the thickness T4 of the core layer 32 may be within a range from 2 mm to 4 mm.

The decorative layer 30 and/or the backing layer 34 may be made of a first material, and the core layer 32 may be made of a second material that is more pliable or flexible than the first material. For example, the first material may be wood, WPC, SPC, MGO, MDF, and/or HDF, as discussed above, and the second material may be cork or a nonwoven material such as a sound deadening pad.

The nonwoven material is made of substrate fibers bound together by thermoplastic binder fibers. The substate fibers may include synthetic fibers such as acrylic fibers and/or thermoplastic fibers (e.g., PET fibers, PP fibers, and/or nylon fibers). In one example, all the substrate fibers are PET fibers, PP fibers, and/or nylon fibers. The PET fibers may have a linear density within a range between 2 denier (den) and 6 den. The PET fibers may have a length within a range from 1 inch to 1.5 inches. Using fiber types other than PET fibers, PP fibers, or nylon fibers in the core layer 32 may lead to the core layer 32 absorbing water, which may cause the wear layer 12, the decorative layer 30, and/or the backing layer 34 to warp.

In addition to or instead of including synthetic fibers, the substrate fibers may include cellulose fibers such as hemp fibers, cotton fibers, denim fibers, and/or paper fibers. The thermoplastic binder fibers may be bicomponent fibers with a fiber core and a sheath surrounding the fiber core. The fiber core may be made of a third material, and the sheath may be made of a fourth material with a lower melting point than the third material. For example, the core may be made of PP or PET, and the sheath may be made of PE or co-PET.

In one example, the core layer 32 includes 48% of short PET fiber by weight, 9% of PP fiber by weight, 3% of nylon by weight, 30% of binder fiber by weight, and 10% of long PET fiber by weight. In other examples, the percentages by weight of the short PET fiber, the PP fiber, the nylon fiber, the binder fiber, and the long PET fiber may be within a range of +/−5%, +/−10%, or +/−20% relative to the above percentages. The length of the nylon fiber and the PET fiber may be within a range from 2 mm to 20 mm. The length of the short PET fiber may be within a range from 2 mm to 10 mm. The length of the long PET fiber may be within a range from 10 mm to 20 mm.

To manufacture the core layer 32, the various types of fibers discussed above are mixed to randomly distribute the thermoplastic binder fibers within the substrate fibers and thereby form a fiber mixture, and the fiber mixture is passed through a compression-type oven. The oven compresses the fiber mixture while heating the fiber mixture. As the oven heats the fiber mixture, the sheath of the bicomponent fiber melts and forms a coating covering most of the fibers in the mixture. After the fiber mixture exits the oven, the fiber mixture is cooled, and the melted sheath solidifies and binds the fibers together to form a fiber structure. The thermoplastic binder fibers may bind to one another to form a fiber matrix, and the substrate fibers may be captured within the fiber matrix to form the fiber structure. The fiber structure may be machined (e.g., cut) to form the core layer 32.

To ensure that the core layer 32 has a density within the density range discussed below, the percentages by weight of short PET fiber and binder fiber in the core layer 32 are greater than those of fiber structures that are less dense, such as flooring underlayment. In addition, the amount of compression applied by the oven when making the core layer 32 is greater than the amount of compression applied by the oven when making less dense fiber structures. This may be accomplished by mixing together a greater amount of fiber than is mixed to make less dense fiber structures and passing the fiber mixture through the oven at a desired minimal thickness. In one example, for a given volume, the amount of fiber used to make the core layer 32 is within a range from 40% to 60% greater than the amount of fiber used to make less dense fiber structures.

In one example, the core layer 32 has a compression resistance within a range from 450 pounds per square inch (psi) at 50% compression to 525 psi at 50% compression when tested according to American Society for Testing and Materials (ASTM) D3575. The compressibility of the core layer 32 may be achieved through the density and/or weight of the core layer 32. In one example, the core layer 32 has a density within a range from 10 pounds per cubic feet (lb/ft³) (160 kilograms per cubic meter (kg/m³)) to 40 lb/ft³ (640 kg/m³). In another example, the core layer 32 has a density within a range from 12.5 lb/ft³ (200 kg/m³) to 26.5 lb/ft³ (425 kg/m³). In another example, the core layer 32 has a density within a range from 18 lb/ft³ (288 kg/m³) to 24 lb/ft³ (384 kg/m³). In yet another example, the core layer 32 has a weight from 1500 grams per square meter (GSM) to 5000 GSM.

In one example, the core layer 32 has an impact insulation class (IIC) within a range from 55 to 80, a sound transmission class (STC) within a range from 52 to 75, and/or a delta IIC within a range from 22 to 28. In one example, the core layer 32 has an R-value within a range from 0.6 to 0.9 or within a range from 3.5 to 4 per inch. While the core layer 32 is suitable for use in a floor covering having an underlayment backing, the sound reduction and thermal insulation provided by the core layer 32 eliminates the need to use a floor underlayment between the floor covering and the subfloor.

Each tongue 16 includes a head 36 and a neck 38. In the example shown, the cross section of the head 26 has a diamond or rhombus shape with rounded corners. Each tongue 16 has a maximum thickness Tmax at the head 36 thereof. Each groove 18 includes a funnel entry 40, a widened section 42, and a u-shaped section 44 with a rounded bottom 46. Each groove 18 has a maximum height Hmax at the widened section 42 thereof. The maximum thickness Tmax of each tongue 16 may be greater than or equal to the maximum height Hmax of each groove 18.

The core layer 32 makes up at least a portion of the male and female edges 15 and 17 of the multilayer flooring 12. As used herein, the term portion means something less than the whole. In the example shown, the core layer 32 makes up a majority of the tongue 16 but less than all of the tongue 16, and the core layer 32 makes up a majority of the rounded bottom 46 of the groove 18 but less than all of the rounded bottom 46. The ratio of the thickness T4 of the core layer 32 to the maximum thickness Tmax of the tongue 16 may be within a range of 0.3 to 0.9. Similarly, the ratio of the thickness T4 of the core layer 32 to the maximum height Hmax of the groove 18 may be within a range of 0.3 to 0.9.

The core layer 32 may not make up portions of the tongue 16 and/or portions of the groove 18 where higher stiffness is desired, such as the top and bottom portions of the tongue 16 and the groove 18 as shown. Making these portions of the tongue 16 and the groove 18 from the first material rather than the second material yields a tighter lock between the tongue 16 and the groove 18 due to the higher rigidity of the first material. In addition, making these portions of the tongue 16 from the decorative and backing layers 30 and 34 prevents the core layer 32 from being visible, which may be desirable for aesthetic reasons. In other examples, the core layer 32 may makeup all of the tongue 16 and/or the core layer 32 may makeup all of groove 18 or at least all of the rounded bottom 46 of the groove 18.

Since the second material from which the core layer 32 is made is relatively flexible or pliable, the tongue 16 of each floorboard 14 compresses when the tongue 16 is inserted into the groove 18 of an adjacent floorboard 14. FIG. 3 shows the tongue 16 uncompressed and compressed using phantom and solid lines, respectively, to illustrate the compression of the tongue 16. The core layer 32 also acts as a hinge during insertion of the tongue 16 into the groove 18 by allowing the portions of floorboard 14 disposed above and below the groove 18 to spread apart from one another. FIG. 3 shows these portions of the floorboard 14 using phantom lines to illustrate how the groove 18 expands when the tongue 16 is inserted into the groove 18.

The compression of the tongue 16 and expansion of the groove 18 enables making the groove 18 to have a size and shape that closely matches the size and shape of the tongue 16, which yields a tighter lock between the tongue and groove 16 and 18. For example, the fit between the tongue and groove 16 and 18 may be an interference fit such as a press fit. In addition, compression of the tongue 16 and expansion of the groove 18 enables disassembling floorboards 14 from one another and reassembling the floorboards 14 to one another without breaking the tongue 16. Furthermore, compression of the tongue 16 and expansion of the groove 18 enables assembling and disassembling the floorboards 14 together by simply moving the floorboards 14 toward or away from one another in a single direction without rotating either floorboard 14.

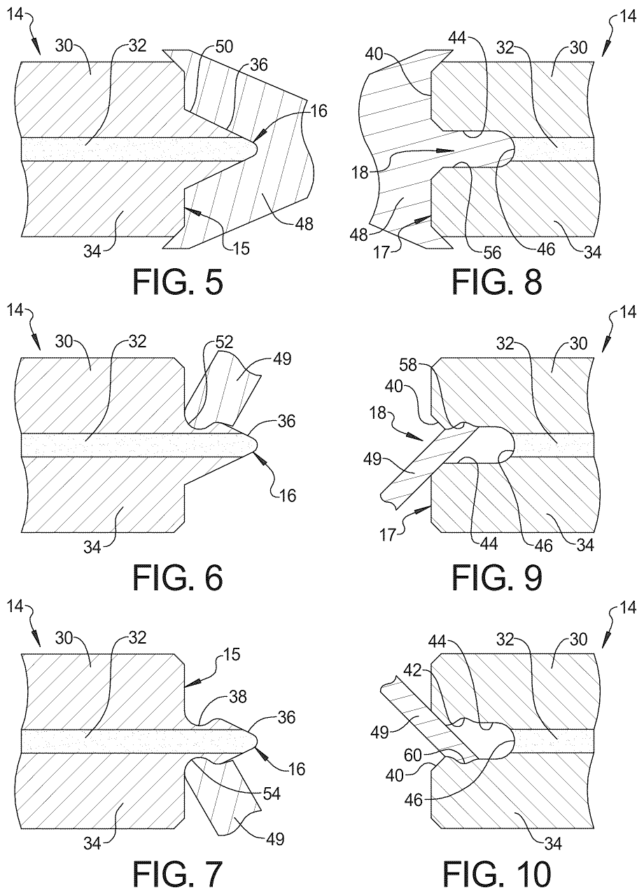

Referring now to FIGS. 5 through 7, a method of forming the tongue 16 on the male edge 15 of each floorboard 14 is shown. In FIG. 5, a first tool 48 is used to make a first cut 50 in the male edge 15. The first tool 48 may be a tool that is useful for making angled cuts in wood or wood-like materials. For example, the first tool 48 may be a compound miter saw, saw blade, router bit, or shaping tool. The first cut 50 yields the beginnings of the head 36 of the tongue 16. After the first cut 50, the head 36 has a triangular shape in cross section.

In FIGS. 5 and 6, a second tool 49 makes second and third cuts 52 and 54 in the male edge 15 to form the neck 38 of the tongue 16. The second tool 49 may be a tool that is useful for making curved cuts in wood or wood-like materials. For example, the second tool 49 may be a saw blade, router bit, or shaping tool, and may be configured to make more precise cuts than the first tool 48. After the second and third cuts 52 and 54, the tongue 16 is fully formed.

Referring now to FIGS. 8 through 10, a method of forming the groove 18 in the female edge 17 of each floorboard 14 is shown. In FIG. 8, the first tool 48 is used to make a first cut 56 in the female edge 17. The first cut 56 creates the funnel entry 40 of the groove 18 and the U-shaped section 44 of the groove 18.

In FIGS. 9 and 10, the second tool 49 makes second and third cuts 58 and 60 in the female edge 17 to form the widened section 42 of the groove 18. Each of the second and third cuts 58 and 60 may yield a notch or v-shaped indentation in the U-shaped section 44 as shown. After the second and third cuts 58 and 60, the groove 18 is fully formed.

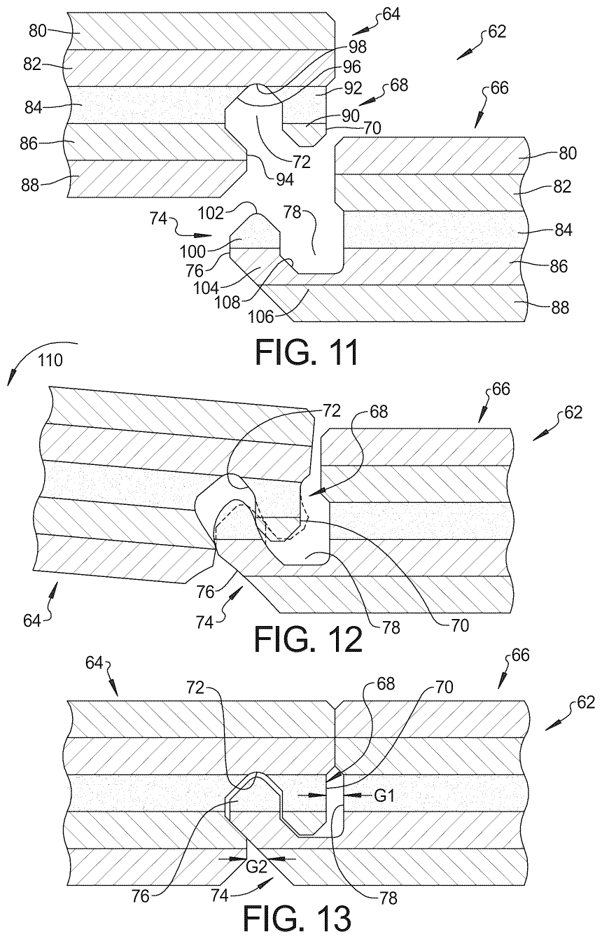

The floorboards of FIGS. 1 through 10 are assembled together by moving one of the floorboards in a sideways or horizontal direction, or primarily a horizontal direction, toward another one of the floorboards. In contrast, the floorboards of FIGS. 11 through 24 are assembled together by moving one of the floorboards in a downward or vertical direction, or primarily a vertical direction, toward another one of the floorboards, and applying a downward force to the one floorboard (e.g., by stepping on the one floorboard) to lock the floorboards toether. The advantage of the vertical direction of assembly is that one of the floorboards may be replaced without disassembling the entire floor structure (e.g., all the floorboards).

Referring now to FIGS. 11 through 13, multilayer flooring 62 made up of a top floorboard 64 and a bottom floorboard 66 may be used in place of the multilayer flooring 12 in the floor structure 10. The top floorboard 64 has an edge 68 defining a tongue 70 and a groove 72, and the bottom floorboard 66 has an edge 74 defining a tongue 76 and a groove 78. The tongue 70 of the top floorboard 64 is inserted into the groove 78 in the bottom floorboard 66, and the tongue 76 of the bottom floorboard 66 is inserted into the groove 72 in the top floorboard 64, to lock the top and bottom floorboards 64 and 66 together. The top floorboard 64 may also have the edge 74 opposite of the edge 68, and the bottom floorboard 66 may also have the edge 68 opposite of the edge 74. The edges 68, 74 of the top and bottom floorboards 64 and 66 extend along the lengths thereof.

In the example shown, each of the top and bottom floorboards 64 and 66 includes a first straight layer 80, a first crossband layer 82, a substrate or core layer 84, a second crossband layer 86, and a second straight layer 88. The first and second straight layers 80 and 88 are made of plywood having a grain direction that extends along the lengths of the top and bottom floorboards 64 and 66 (e.g., in the direction of the length L shown in FIG. 1). The first and second crossband layers 82 and 86 are made of plywood having a grain direction that extends across the widths of the top and bottom floorboards 64 and 66 (e.g., in the direction of the width W shown in FIG. 1). The core layer 84 may be similar or identical to the core layer 32. The first straight layer 80, the first crossband layer 82, the core layer 84, the second crossband layer 86, and the second straight layer 88 may be joined to one another using adhesive.

In various implementations, each of the top and bottom floorboards 64 and 66 may include additional layers (e.g., 7 or 9 layers) or fewer layers (e.g., 3 layers). Additionally or alternatively, the non-core layers of the top and bottom floorboards 64 and 66 may be made of a material other than plywood. For example, each of the top and bottom floorboards 64 and 66 may be made up of the decorative layer 30, the core layer 32, and the backing layer 34. Thus, the multilayer flooring 62 may be identical to the multilayer flooring 12 except for differences between the geometry of the edges 68, 74 of the floorboards 64, 66 and the geometry of the edges 15, 17 of the floorboards 14.

The tongue 70 of the top floorboard 64 has a head 90 and a neck 92. The head 90 has a hexagonal shape in cross section. The groove 72 in the top floorboard 64 has a funnel entry 94 and a hexagonal section 96 with a rounded top 98. The tongue 76 of the bottom floorboard 66 has a head 100 with a rounded top 102 and a neck including a first neck section 104 and and a second neck section 106. The head 100 has a hexagonal shape in cross section, the first neck section 104 has a trapezoidal shape in cross section, and the second neck section 106 has a rectangular shape in cross section. The groove 78 in the bottom floorboard 66 has a rectangular shape in cross section with a chamfered edge 108.

The tongue 70 of the top floorboard 64 is complementary in shape to at least a portion of the groove 78 in the bottom floorboard 66. The width of the groove 78 in the bottom floorboard 66 may be slightly larger than the width of the tongue 70 of the top floorboard 64 to yield a first gap G1 between the tongue 70 and the groove 78 when the top and bottom floorboards 64 and 66 are joined together. The head 100 of the tongue 76 of the bottom floorboard 66 is complementary in shape to the hexagonal section 96 of the groove 72 in the top floorboard 64. The funnel entry 94 of the groove 72 in the top floorboard 64 may be slightly larger than the first neck section 104 of the tongue 76 of the bottom floorboard 66 to yield a second gap G2 between the tongue 76 and the groove 72 when the top and bottom floorboards 64 and 66 are joined together. The first and second gaps G1 and G2 may facilitate insertion of the tongues 70, 76 into the grooves 78, 72, respectively. Apart from the first and second gaps G1 and G2, the tongues 70, 76 may fill the grooves 78, 72 with little to no clearance therebetween.

The tongue 70 of the top floorboard 64 is made up of the core layer 84 and the second crossband layer 86. The tongue 76 of the bottom floorboard 66 is made up of the core layer 84, the second crossband layer 86, and the second straight layer 88. Since both of the tongues 70, 76 are made of the core layer 84, the tongues 70, 76 are able to flex or deform by a greater amount than a conventional floorboard tongue. Since the tongue 76 is made of both the second crossband layer 86 and the second straight layer 88, the tongue 76 has a greater strength than if the tongue 76 were made up of only the second crossband layer 86 or the second straight layer 88 like the tongue 70. This is beneficial since the tongue 76 is longer than the tongue 70.

FIGS. 11 through 13 illustrate assembly of the top and bottom floorboards 64 and 66 to one another. FIG. 11 shows the top and bottom floorboards 64 and 66 disassembled from one another with the edge 68 of the top floorboard 64 spaced apart from the edge 74 of the bottom floorboard 66. FIG. 12 shows the tongue 70 of the top floorboard 64 being inserted into the groove 78 of the bottom floorboard 66 and the tongue 76 of the bottom floorboard 66 being inserted into the groove 72 of the top floorboard 64. FIG. 13 shows the top and bottom floorboards 64 and 66 joined together with the tongue 70 of the top floorboard 64 fully inserted into the groove 78 of the bottom floorboard 66 and the tongue 76 of the bottom floorboard 66 fully inserted into the groove 72 of the top floorboard 64.

As shown in FIG. 12, the top floorboard 64 may be positioned with its edge 68 lower than the opposite edge of the top floorboard 64 when the tongues 70, 76 are initially inserted into the grooves 78, 72, respectively. Then, the top floorboard 64 may be rotated in a direction 110 as the tongues 70, 76 are fully inserted into the grooves 78, 72, respectively. Alternatively, the top floorboard 64 may be positioned with its edge 68 at same vertical level as its opposite edge, and the top floorboard 64 may be moved downward toward the bottom floorboard 66 without rotating the top floorboard 62. The flexibility of the core layer 84 allows the tongue 70 to rotate into the first gap G1 until the tongue 70 is fully inserted into the groove 78, at which point the tongue 70 snaps back to its original position.

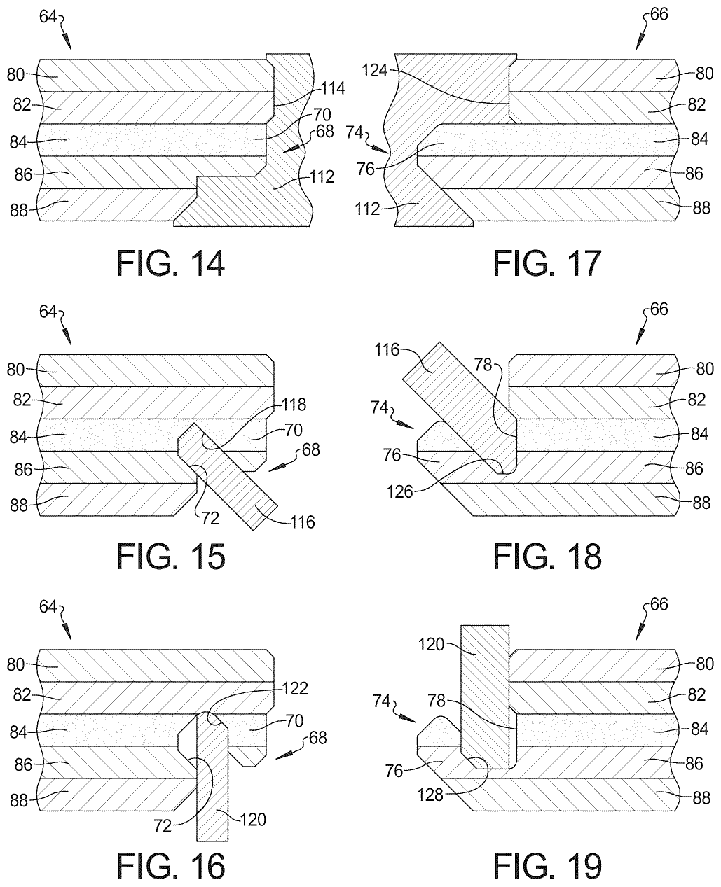

Referring now to FIGS. 14 through 16, a method of forming the edge 68 on the top floorboard 64 is shown. In FIG. 14, a first tool 112 is used to make a first cut 114 in the edge 68. The first tool 112 may be a rotary tool with a first type and/or size of cutter. The first cut 114 yields the beginnings of the tongue 70.

In FIG. 15, a second tool 116 is used to make a second cut 118 in the edge 68. The second tool 116 may be the rotary tool with a second type and/or size of cutter. The second cut 118 further forms the tongue 70 and yields the beginnings of the groove 72. In FIG. 16, a third tool 120 is used to make a third cut 122 in the edge 68. The third tool 120 may be the rotary tool with a third type and/or size of cutter. After the third cut 122, the tongue 70 and the groove 72 are fully formed.

Referring now to FIGS. 17 through 19, a method of forming the edge 74 on the bottom floorboard 66 is shown. In FIG. 17, the first tool 112 is used to make a first cut 124 in the edge 74. The first cut 124 yields the beginnings of the tongue 76.

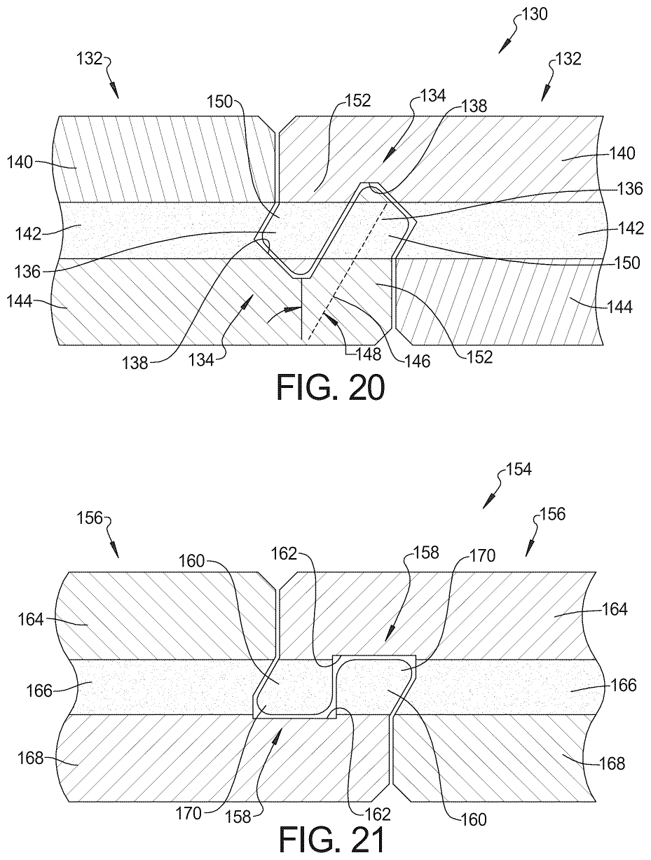

In FIG. 18, the second tool 116 is used to make a second cut 126 in the edge 74. The second cut 126 further forms the tongue 76 and yields the beginnings of the groove 78. In FIG. 19, the third tool 120 is used to make a third cut 128 in the edge 74. After the third cut 128, the tongue 76 and the groove 78 are fully formed.

The multilayer flooring 62 of FIGS. 11 through 19 is asymmetrical in that the edge 68 of the top floorboard 64 has a different geometry than the edge 74 of the bottom floorboard 66. In contrast, the multilayer flooring of FIGS. 20 through 24 is symmetrical in that the edge of one floorboard has the same geometry as the edge of the other floorboard that joins the edge of the one floorboard. This enables using the floorboards interchangeably without regard to which edges are being joined together.

Referring now to FIG. 20, multilayer flooring 130 made up of floorboards 132 may be used in place of the multilayer flooring 12 in the floor structure 10. Each floorboard 132 has an edge 134 extending along the length thereof and defining a tongue 136 and a groove 138. The edge of each floorboard 132 opposite of the edge 134 may be identical to the edge 134. The tongue 136 of one floorboard 132 is inserted into the groove 138 of the other floorboard 134 to lock the floorboards 132 together.

Each floorboard 132 includes a decorative layer 140, a substrate or core layer 142, and a backing layer 144, which may be joined to one another using adhesive. The decorative layer 140, the core layer 142, and the backing layer 144 may be similar or identical to the decorative layer 30, the core layer 32, and the backing layer 34, respectively. Thus, the multilayer flooring 130 may be similar or identical to the multilayer flooring 12 except for differences between the geometry of the edges 134 of the floorboards 132 and the geometry of the edges 15, 17 of the floorboards 14.

The tongue 136 of each floorboard 132 extends along an axis 146 oriented at an acute angle 148 with respect to vertical. Each tongue 136 includes a head 150 and a neck 152. The width of the neck 152 narrows as it extends from the point where the tongue 136 attaches to the rest of the floorboard 132 to the point where the head 150 attaches to the neck 152. The width of the head 150 is relatively constant as it extends from the neck 152 to the distal end of the tongue 136. Thus, the head 150 may be symmetrical with respect to the axis 146. The tongue 136 of each floorboard 132 is made up of the decorative layer 140, the core layer 142, and the backing layer 144.

Referring now to FIG. 21, multilayer flooring 154 made up of floorboards 156 may be used in place of the multilayer flooring 12 in the floor structure 10. Each floorboard 156 has an edge 158 extending along the length thereof and defining a tongue 160 and a groove 162. The edge of each floorboard 156 opposite of the edge 158 may be identical to the edge 158. The tongue 160 of one floorboard 156 is inserted into the groove 162 of the other floorboard 156 to lock the floorboards 156 together.

Each floorboard 156 includes a decorative layer 164, a substrate or core layer 166, and a backing layer 168, which may be joined to one another using adhesive. The decorative layer 164, the core layer 166, and the backing layer 168 may be similar or identical to the decorative layer 30, the core layer 32, and the backing layer 34, respectively. Thus, the multilayer flooring 154 may be similar or identical to the multilayer flooring 12 except for differences between the geometry of the edges 158 of the floorboards 156 and the geometry of the edges 15, 17 of the floorboards 14.

The tongue 160 of each floorboard 156 extends vertically (e.g., at a zero angle with respect to vertical). The tongue 160 of each floorboard 156 includes a ramped protrusion 170 that protrudes horizontally (e.g., at a right angle with respect to vertical) away from the groove 162 in the same edge 158. The ramped protrusion 170 may have a triangular shape with a rounded corner in cross section, and the rest of the tongue 160 may have a rectangular shape with a rounded corner in cross section. The ramped protrusion 170 may be referred to as an overhang. The tongue 160 of each floorboard 156 is made up entirely of the core layer 166, or at least a majority of the tongue 160 is made up of the core layer 166. The flexibility of the core layer 166 enables compressing or crushing the tongue 160 as the tongue 160 is partially inserted into the groove 162, and then the tongue 160 returns to its original state when the tongue 160 is fully inserted into the groove 162.

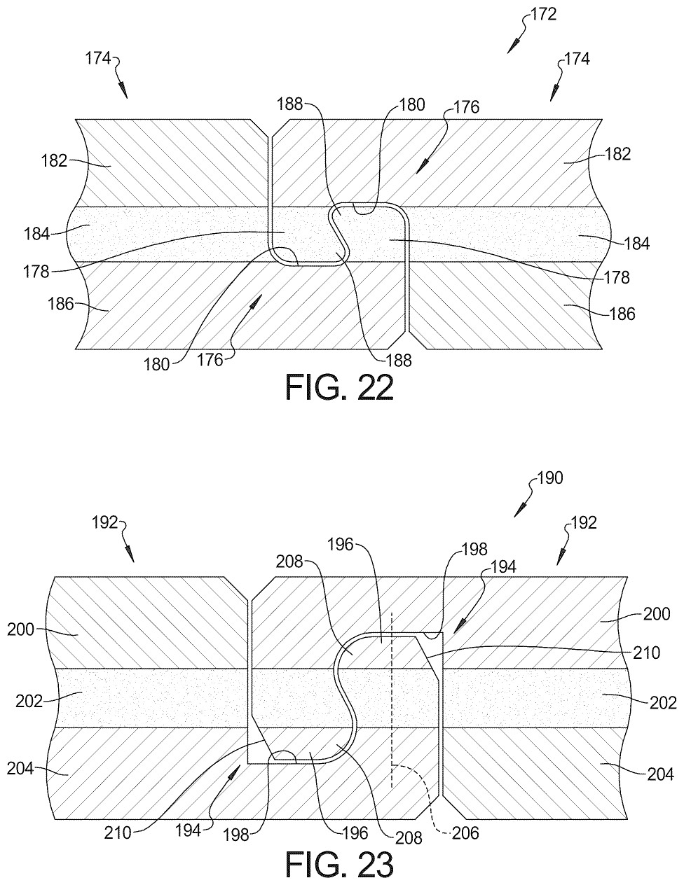

Referring now to FIG. 22, multilayer flooring 172 made up of floorboards 174 may be used in place of the multilayer flooring 12 in the floor structure 10. Each floorboard 174 has an edge 176 extending along the length thereof and defining a tongue 178 and a groove 180. The edge of each floorboard 174 opposite of the edge 176 may be identical to the edge 176. The tongue 178 of one floorboard 174 is inserted into the groove 180 of the other floorboard 174 to lock the floorboards 174 together.

Each floorboard 174 includes a decorative layer 182, a substrate or core layer 184, and a backing layer 186, which may be joined to one another using adhesive. The decorative layer 182, the core layer 184, and the backing layer 186 may be similar or identical to the decorative layer 30, the core layer 32, and the backing layer 34, respectively. Thus, the multilayer flooring 172 may be similar or identical to the multilayer flooring 12 except for differences between the geometry of the edges 176 of the floorboards 174 and the geometry of the edges 15, 17 of the floorboards 14.

The tongue 178 of each floorboard 174 extends vertically. The tongue 178 of each floorboard 174 includes a ramped protrusion 188 that protrudes horizontally toward the groove 180 in the same edge 176. The ramped protrusion 188 may have a triangular shape with a rounded corner in cross section, and the rest of the tongue 178 may have a rectangular shape with a rounded corner in cross section. The ramped protrusion 188 may be referred to as an overhang. The tongue 178 of each floorboard 174 is made up entirely of the core layer 184, or at least a majority of the tongue 174 is made up of the core layer 184. The flexibility of the core layer 184 enables compressing or crushing the tongue 178 as the tongue 178 is partially inserted into the groove 180, and then the tongue 178 returns to its original state when the tongue 178 is fully inserted into the groove 180.

Referring now to FIG. 23, multilayer flooring 190 made up of floorboards 192 may be used in place of the multilayer flooring 12 in the floor structure 10. Each floorboard 192 has an edge 194 extending along the length thereof and defining a tongue 196 and a groove 198. The edge of each floorboard 192 opposite of the edge 194 may be identical to the edge 194. The tongue 192 of one floorboard 192 is inserted into the groove 198 of the other floorboard 192 to lock the floorboards 192 together.

Each floorboard 192 includes a decorative layer 200, a substrate or core layer 202, and a backing layer 204, which may be joined to one another using adhesive. The decorative layer 200, the core layer 202, and the backing layer 204 may be similar or identical to the decorative layer 30, the core layer 32, and the backing layer 34, respectively. Thus, the multilayer flooring 190 may be similar or identical to the multilayer flooring 12 except for differences between the geometry of the edges 194 of the floorboards 192 and the geometry of the edges 15, 17 of the floorboards 14.

The tongue 196 of each floorboard 192 extends along a vertical axis 206 and is asymmetric with respect to the vertical axis 206. In this regard, the tongue 192 of each floorboard 192 includes a rounded protrusion 208 that protrudes horizontally toward the groove 198 in the same edge 196, and the tongue 196 of each floorboard 192 has a chamfered edge 210. The ramped protrusion 208 may be referred to as an overhang. The overhangs of the tongues 196 (or other tongues described herein) ensure that the floorboards 192 (or other floorboards described herein) are securely locked together. The tongue 196 of each floorboard 192 is made up of the decorative layer 200, the core layer 202, and the backing layer 204.

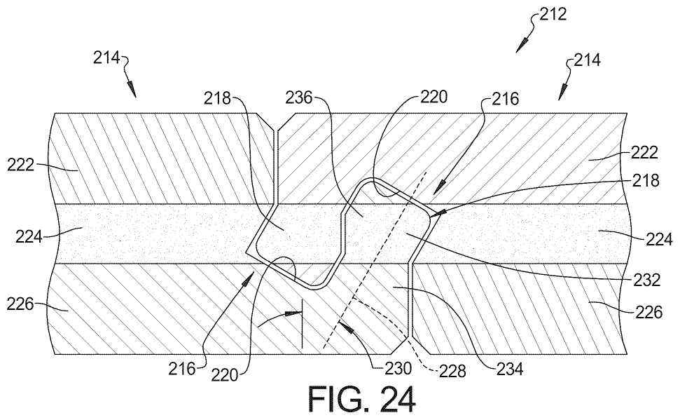

Referring now to FIG. 24, multilayer flooring 212 made up of floorboards 214 may be used in place of the multilayer flooring 12 in the floor structure 10. Each floorboard 214 has an edge 216 extending along the length thereof and defining a tongue 218 and a groove 220. The edge of each floorboard 214 opposite of the edge 216 may be identical to the edge 216. The tongue 218 of one floorboard 214 is inserted into the groove 220 of the other floorboard 214 to lock the floorboards 214 together.

Each floorboard 214 includes a decorative layer 222, a substrate or core layer 224, and a backing layer 226, which may be joined to one another using adhesive. The decorative layer 222, the core layer 224, and the backing layer 226 may be similar or identical to the decorative layer 30, the core layer 32, and the backing layer 34, respectively. Thus, the multilayer flooring 212 may be similar or identical to the multilayer flooring 12 except for differences between the geometry of the edges 216 of the floorboards 214 and the geometry of the edges 15, 17 of the floorboards 14.

The tongue 218 of each floorboard 214 extends along an axis 228 oriented at an acute angle 230 with respect to vertical. Each tongue 218 includes a head 232 and a neck 234. The width of the neck 234 narrows as it extends from the point where the tongue 218 attaches to the rest of the floorboard 214 to the point where the head 232 attaches to the neck 234. The width of the head 150 initially widens as it extends from the neck 152 toward the distal end of the tongue 136 and then is relatively constant near the distal end. This widening of the head 150 yields a ramped protrusion 236 that protrudes toward the groove 220 on the same edge 216. The tongue 218 of each floorboard 214 is made up of the decorative layer 222, the core layer 224, and the backing layer 226.

Each example of multilayer flooring described herein includes a locking system formed by a locking barb or tongue on one floorboard that is inserted into a locking cavity or groove in another floorboard to lock the floorboards together. In one example, the locking system utilizes a flexible core that allows the tongue to compress and the groove to open so that the tongue can be inserted and also removed. In another example, the locking system utilizes a flexible core that allows the tongue to be inserted by allowing the tongue to rotate into a void in the groove and then snap back into place outside of the void when the tongue is fully inserted into the groove, and the locking system is disassembled in the reverse sequence. In another example, the locking system utilizes a flexible core that allows the tongue to be inserted into the groove by crushing the tongue (made out of the core) while the groove engages the tongue, and then the tongue snaps back to its original shape when the tongue is fully inserted into the groove, and the locking system is disassembled in the reverse sequence.

The multilayer flooring described herein is not limited to flooring applications. In this regard, the multilayer flooring described herein may be referred to as multilayer structure, and the floorboards described herein may simply be referred to as boards. The joint between the boards is “blind” in that it is not be visible, which may be particularly beneficial for certain applications. For example, the multilayer structure may be used to form walls (e.g., interior partitions in “tiny homes”) or kitchen cabinet.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Spatially relative terms, such as “inner,” “outer,” “beneath,” “below,” “lower,” “above,” “upper,” “top,” “bottom” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term “and/or” includes any and all combinations of one or more of the associated listed items. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A multilayer flooring comprising:
floorboards that each have a male edge and a female edge, the male edge including a tongue, the female edge defining a groove, wherein the tongue of one of the floorboards is insertable into the groove of another one of the floorboards to lock the floorboards together, each of the floorboards including:
a decorative layer configured to provide a desired appearance of the multilayer flooring, wherein the decorative layer is made of a first material; and
a core layer disposed below the decorative layer and configured to provide at least one of stability, sound deadening, cushioning, and durability, wherein the core layer is made of a second material that is less rigid than the first material, and the core layer makes up at least a portion of at least one of the tongue and the groove.

2. The multilayer flooring of claim 1 wherein a ratio of a thickness of the core layer to at least one of a maximum thickness of the tongue and a maximum height of the groove is within a range from 0.3 to 0.9.

3. The multilayer flooring of claim 1 wherein the first material is selected from a group consisting of wood, wood plastic composite (WPC), stone plastic composite (SPC), magnesium oxide (MGO), medium-density fiberboard (MDF), and high-density fiberboard (HDF), and the second material is selected from a group consisting of cork and a nonwoven material.

4. The multilayer flooring of claim 1 wherein the decorative layer makes up a top portion of at least one of the tongue and the groove.

5. The multilayer flooring of claim 1 further comprising a backing layer disposed below the core layer, wherein the decorative and backing layers make up top and bottom portions, respectively, of at least one of the tongue and the groove.

6. The multilayer flooring of claim 5 wherein the backing layer is also made of the first material.

7. A multilayer flooring comprising:
a first floorboard having a first edge defining a first tongue and a first groove; and
a second floorboard having a second edge defining a second tongue and a second groove, wherein the first tongue of the first floorboard is insertable into the second groove of the second floorboard, and the second tongue of the second floorboard is insertable into the first groove in the first floorboard, to lock the first and second floorboards together, each of the first and second floorboards including:
a first layer;
a second layer; and
a core layer disposed between the first and second layers, wherein at least one of the first and second layers is made of a first material and the core layer is made of a second material that is less rigid than the first material, and the core layer makes up at least a portion of the first and second tongues.

8. The multilayer flooring of claim 7 wherein both the first and second layers are made of the first material.

9. The multilayer flooring of claim 7 wherein the first material is selected from a group consisting of wood, wood plastic composite (WPC), stone plastic composite (SPC), magnesium oxide (MGO), medium-density fiberboard (MDF), and high-density fiberboard (HDF), and the second material is selected from a group consisting of cork and a nonwoven material.

10. The multilayer flooring of claim 7 wherein the core layer makes up at least a portion of the first and second grooves.

11. The multilayer flooring of claim 7 further comprising a third layer disposed above the first layer and a fourth layer disposed below the second layer, wherein the first, second, third, and fourth layers are made of the first material.

12. The multilayer flooring of claim 11 wherein the first material is wood, the first and second layers having a grain direction that extends along one of a floorboard length and a floorboard width, the third and fourth layers having a grain direction that extends along the other one of the floorboard length and the floorboard width.

13. The multilayer flooring of claim 7 wherein the geometry of the first edge of the first floorboard is different than the geometry of the second edge of the second floorboard.

14. The multilayer flooring of claim 7 wherein the geometry of the first edge of the first floorboard is identical to the geometry of the second edge of the second floorboard.

15. A multilayer flooring comprising:
a first floorboard having an edge defining a tongue;
a second floorboard having an edge defining a groove, wherein the tongue of the first floorboard is insertable into the groove of the second floorboard to lock the first and second floorboards together, each of the first and second floorboards including:
a first layer;
a second layer; and
a core layer disposed between the first and second layers, wherein:
at least one of the first and second layers is made of a first material;
the core layer is made of a second material that is less rigid than the first material;
the core layer makes up at least a portion of the tongue; and
the first and second floorboards can be disassembled from one another without breaking the tongue.

16. The multilayer flooring of claim 15 wherein the first and second floorboards are assembled to one another by moving one of the first and second floorboards in a primarily horizontal direction toward the other one of the first and second floorboards.

17. The multilayer flooring of claim 15 wherein the first and second floorboards are assembled to one another by moving one of the first and second floorboards in a primarily vertical direction toward the other one of the first and second floorboards.

18. The multilayer flooring of claim 15 wherein the core layer makes up a majority of the tongue.

19. The multilayer flooring of claim 15 wherein:
the edge of the first floorboard also defines a groove and the edge of the second floorboard also defines a tongue; and
the tongues of the first and second floorboard are insertable into the grooves of the first and second floorboards to lock the first and second floorboards together.

20. The multilayer flooring of claim 15 wherein:
one edge of the first floorboard defines the tongue and the opposite edge of the first floorboard defines a groove;
one edge of the second floorboard defines the groove in the second floorboard and the opposite edge defines a tongue;
the tongues of the first and second floorboard are insertable into the grooves of the first and second floorboards to lock the first and second floorboards together;
the multilayer flooring comprises a plurality of the first floorboard and a plurality of the second floorboard; and
when the first and second floorboards are assembled together with the first floorboards disposed between adjacent ones of the second floorboards, one of the first or second floorboards disposed between adjacent ones of the other one of the first or second floorboards can be disassembled from the multilayer flooring without disassembling other ones of the first and second floorboards or breaking the tongues.
